(19) United States
(12) Patent Application Publication
(10) Pub. No.: US 2006/0167849 A1
(43) Pub. Date: Jul. 27, 2006

(54) Method and system for mobile instant messaging using multiple protocols

(75) Inventors: David A. Marcus, Geneva (CH); Raoul Beck, Geneva (CH); Eyal Fussfeld, Collex (CH); Sorin Stirbu, Geneva (CH)

Correspondence Address: SQUIRE, SANDERS & DEMPSEY L.L.P, 600 HANSEN WAY, PALO ALTO, CA, 94304-1043, US

(73) Assignee: ECHOVOX SA

(21) Appl. No.: 11/044,692

(22) Filed: Jan. 26, 2005

(51) Int. Cl. G06F 17/30

(52) U.S. Cl. 707/3

(57) ABSTRACT

A method, system and computer program to engage and conduct instant messaging sessions on mobile devices. The system uses the GPRS protocol as the principal carrier to exchange messages in between users that are running their instant messaging application. The system further allows users who are not running their instant messaging application to be invited through SMS messages. Combining both protocols allows users to engage into an instant messaging session regardless of the status of their instant messaging application on their mobile device. A method may comprise initiating an instant messaging session; sending an instant message to a buddy; if the buddy is connected and engaged, then sending the instant message to the buddy; and if the buddy is disconnected, then sending an offline notification to the buddy. If the buddy is connected, then the instant message may be sent to the buddy using a GPRS protocol. The offline notification may be an SMS message indicating that an instant messaging session is available to the buddy. The method may also comprise, if the buddy is connected and disengaged, then sending a notification identifying the instant messaging session to the buddy.

### BACKGROUND

1. Technical Field

The present invention relates to telecommunication and more specifically to messaging applications running on wireless devices.

2. Description of the Background Art

Mobile phones were originally designed to enable voice communications to be conducted over wireless channels, allowing people to communicate in remote locations where land lines would be unavailable. The first technologies used were analog and only allowed for voice traffic.

Soon thereafter, digital technologies were adopted. In Europe, the driving standard is GSM (Global Standard for Mobile Devices) and in the United States the driving standard is D-AMPS (Digital Advanced Mobile Phone Service). These standards not only allow for voice communications, but also allow for transmission of data packets. For example, the SMS (Short Message Service) protocol is extensively used to send and receive short text messages and MMS (Multimedia Message Service) for rich content such as text and images.

Another wireless protocol is GPRS (General Packet Radio Service) that allows data packets to be exchanged asynchronously between users. The GPRS protocol can be used to exchange IP based data packets, allowing users to connect and communicate with websites on the wide area network commonly referred to as the Internet or the World Wide Web.

Voice communications over mobile phones require a dedicated channel between the mobile phone and the network transmitter. The dedicated channel is locked for a given user during a voice communication. On the other hand, the GPRS protocol is based on time-sharing of a carrier signal. A GPRS message is divided into packets. A device communicating using the GPRS protocol captures only the packets needed (e.g., the packets that are addressed to it), and ignores the remaining packets.

Because the carrier is shared, the GPRS protocol is always available. Unless the user is using a dedicated channel for a voice communication, the mobile device can access the GRPS channel at any time, without the need to connect, much like a PC connected to the Internet. The time-sharing nature of GPRS makes it an ideal carrier for applications such as instant messaging, where full-time transmission is not required, but real-time transmission is necessary.

Contrarily, the SMS and MMS protocols are activated for short connections between the mobile device and the network.

These fundamental characteristics of GPRS and SMS/MMS have motivated mobile operators to offer two distinct methods for message exchange over wireless networks.

(a) The first distinct method uses SMS to send short messages (160 characters max.) or MMS for associated pictures. The recipient of a message retrieves queued SMS/MMS messages whenever his or her device is connected. If disconnected when an SMS/MMS message is sent, the SMS/MMS message is stored within the operator's network for given period of time. One advantage of the SMS/MMS protocol is that messages can be sent to devices, even when they are disconnected to the, network. One drawback is that threads are not provided nor maintained in a logical sequence. It is up to the user to reconstruct the sequence of messages. It is to be noted that in the context of the present invention both the SMS and MMS formats are fulfilling that same functionality and will be called SMS, regardless of whether it contains only text or richer content.

(b) The second distinct method uses GPRS to transmit an IP-based communication. As mentioned earlier, GPRS is an “always-on” protocol, allowing real-time message exchange, such as “chats” or “instant messaging.” Instant messaging is popular both as a World Wide Web application and as a mobile device application. Users belonging to a given community (often referred to as, “buddies” or “friends”) can exchange text messages in real-time. One advantage of instant messaging using GPRS is real-time communication among a community of buddies. In other words, using GPRS, a message can be sent to a large number of participants at once (unlike SMS that can exchange messages between only two participants at a time). In addition, GPRS is less costly than SMS, since it uses a time-shared channel. However, one drawback of GPRS is that buddies need be connected and running their instant messaging applications in order to exchange messages.

### SUMMARY

In one embodiment, the present invention enables the capability to notify users who are disconnected or not running their instant messaging (IM) applications by an SMS message. In other words, disconnected users can be invited to join an instant messaging session. The activation of this additional protocol can be fully integrated within the instant messaging application and can therefore be transparent to the user.

In another embodiment, the present invention provides a method comprising initiating an instant messaging session; sending an instant message to a buddy; if the buddy is connected and engaged, then sending the instant message to the buddy; and if the buddy is disconnected, then sending an offline notification to the buddy. If connected, then the instant message may be sent to the buddy using a GPRS protocol. The offline notification may be an SMS message indicating that an instant messaging session is available to the buddy. The method may also comprise, if the buddy is connected and disengaged in the session, then sending a notification identifying the instant messaging session to the buddy.

In another embodiment, the present invention provides another method comprising receiving by a buddy an offline notification that an instant messaging session is available; accessing a server in which a plurality of instant messaging sessions are stored; receiving identification of the instant messaging session from the server; enabling access to the instant messaging session; and enabling review of the messages of the instant messaging session. The identification of the instant messaging session may be based on the identification of the buddy. The instant messaging session may be ongoing or ended. The steps of receiving, enabling access, and enabling review may use the GPRS protocol. The offline notification may be an SMS message indicating that an instant messaging session is available to the buddy.

In yet another embodiment, the present invention provides a method comprising launching an instant messaging session; receiving a list of predefined buddies from a server; enabling selection of at least one of the buddies from the predefined list for an instant messaging session; and initiating the sending of an instant message to the selected at least one buddy. The method may also comprise, if the buddy is connected and engaged, then sending the instant message to the buddy; if the buddy is connected and disengaged, then sending a notification of the instant messaging session to the buddy to enable access to the instant message session; and if the buddy is disconnected, then sending to the buddy an offline message indicating that an instant message session is available to the buddy. The instant message may be sent via GPRS. The notification of the instant message session may also be sent via GPRS. The offline message may be an SMS notification.

### BRIEF DESCRIPTION OF THE DRAWINGS

FIG. 1. is a block diagram illustrating a network architecture in accordance with an embodiment of the present invention.

FIG. 2 is a block diagram illustrating details of a server in accordance with an embodiment of the present invention.

FIG. 3 is a block diagram illustrating details of a client in accordance with an embodiment of the present invention.

FIG. 4 is a block diagram illustrating details of an example computer system in accordance with an embodiment of the present invention.

FIG. 5 is a flowchart illustrating an example method of conducting an instant messaging session in accordance with an embodiment of the present invention.

### DETAILED DESCRIPTION OF THE PREFERRED EMBODIMENTS

The following description is provided to enable any person skilled in the art to make and use the invention, and is provided in the context of a particular application and its requirements. Various modifications to the embodiments will be readily apparent to those skilled in the art, and the generic principles defined herein may be applied to other embodiments and applications without departing from the spirit and scope of the invention. Thus, the present invention is not intended to be limited to the embodiments shown, but is to be accorded the widest scope consistent with the principles, features and teachings disclosed herein.

In one embodiment, a method combines use of both GPRS and SMS protocols to allow buddies that are disconnected to an instant messaging session to be alerted and invited to join an instant messaging session (whether in progress or completed). In another embodiment, a system conducts an instant messaging (IM) session using GPRS and SMS protocols over wireless devices. A user sending an instant message need not know whether a buddy is currently connected to an IM session. Further, in another embodiment, a user, after having been invited by an SMS message, can retrieve all past messages of an IM session that were exchanged during his absence and can participate in the IM session if it is still ongoing.

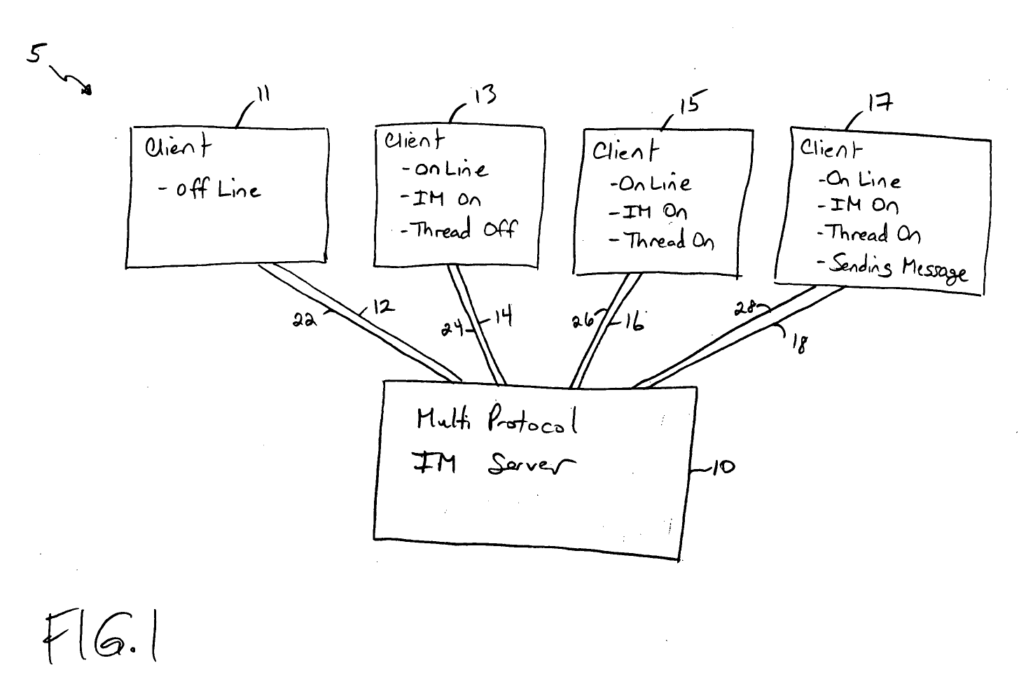

FIG. 1 shows a network architecture 5, in accordance with an embodiment of the present invention. The network system 5 includes a multiprotocol instant messaging server 10 coupled to one or more clients 11, 13, 15 and/or 17, possibly running on mobile phones or other mobile devices. Clients 11, 13, 15 and 17 are coupled to the server 10 via online (e.g., GPRS) channels 12, 14, 16 and 18, respectively, and via offline (e.g., SMS) channels 22, 24, 26 and 28, respectively. Although the network architecture is being described as using GPRS and SMS protocols, one skilled in the art will recognize that any online and offline protocols can alternatively be used.

The clients 11, 13, 15 and/or 17 can be in four different status modes.

(1) Client 11 is currently off-line, referred to herein as “disconnected.” For example, the mobile phone may be turned on, but not running the IM application or in a region where there is no GRPS available.

(2) Client 13 is online, running the IM application, but currently not following (or connected to) a given thread (or session). Client 13 is referred to as “connected” but not “engaged” in the IM session.

(3) Client 15 is online, running the IM application, and reading the messages being sent to a given thread. Client 15 is referred to as “connected” and “engaged” in the IM session.

(4) Client 17 is online, running the IM application, and is sending (and possibly receiving) messages to a given thread. Client 17 is referred to as “connected,” “engaged” and “the initiator.”

Each of clients 11, 13, 15 and/or 17 represents a class of clients and not necessarily individual clients. If there are five users that are running their IM application and reading the messages of the same thread, then the client 15 represents these five clients. The same message exchange will occur for each client 15 individually.

Although the IM application is being described as a dedicated software, one skilled in the art will recognize that many generic applications, such as web browsers can render the same functionality.

In one embodiment, before initiating an IM session, users must first register for the service and install the IM application on their mobile device. Registration may include the identification of a list of buddies with whom the user may want to chat. Then, client 17 launches the IM application and connects to the server 10 using the GPRS link 18 for a login request. If client 17 is a registered user, the server 10 will enlist client 17 as an active user and returns the buddy list of the user to the client 17 via GPRS link 18, regardless whether these buddies are currently active or not. In this embodiment, the buddy list stored on the server 10, and sent by the server 10 to the client 17 via the GPRS link 18. The term “active” is intended to identify those clients who have downloaded the IM client software and registered as an active user. The system may only be available to active users. An SMS message may still be sent to the user, with instructions to the user how to download the IM client software and register as an active user. For convenience, “disconnected clients” should include “inactive clients.”

The client 17 selects the buddies with whom he wants to chat from the list and sends a message to the server 10, identified by a given thread (or session ID). The server 10 automatically sends the message to client 15 via the GPRS link 16, as the client 15 is an active user, currently connected and engaged to that given thread. The server 10 will also send a thread update notification message to client 13, via GPRS link 14, as client 13 is an active and connected client running the IM application but is disengaged to that specific thread. Thread update notification messages do not contain the original messages sent by the clients participating in the thread. In other words, in this embodiment, the message includes only a notification flag indicating that a new message is available from that thread. The notification flag may be in the form of a number, indicating the number of unread messages available on the thread. As stated above, all of the above messages are sent using the GPRS protocol, as GPRS is available to clients 13, 15 and 17 through their IM applications.

Since client 11 is disconnected (e.g., is not running his IM application) and cannot receive messages nor thread update notification messages via its GPRS link 12, the server 10 automatically sends an SMS message to client 11 via SMS link 22. In this embodiment, the SMS message invites client 11 to join the IM session. Since the message sent by client 17 is an instant message, it will not be contained in the SMS message (as it may not comply with the restrictions imposed by SMS messages such as character set or maximum size).

The server 10 stores the IM message chain in memory (and/or any storage device therein) along with its attributes such as date/time, identifier of the sender, identifier of the intended recipients, and identifier of the thread, etc. The server 10 enables the disconnected client 11 to later review the IM message chain when client 11 connects. Further, the server 10 may enable the other clients 13, 15 and/or 17 access to the IM message chain.

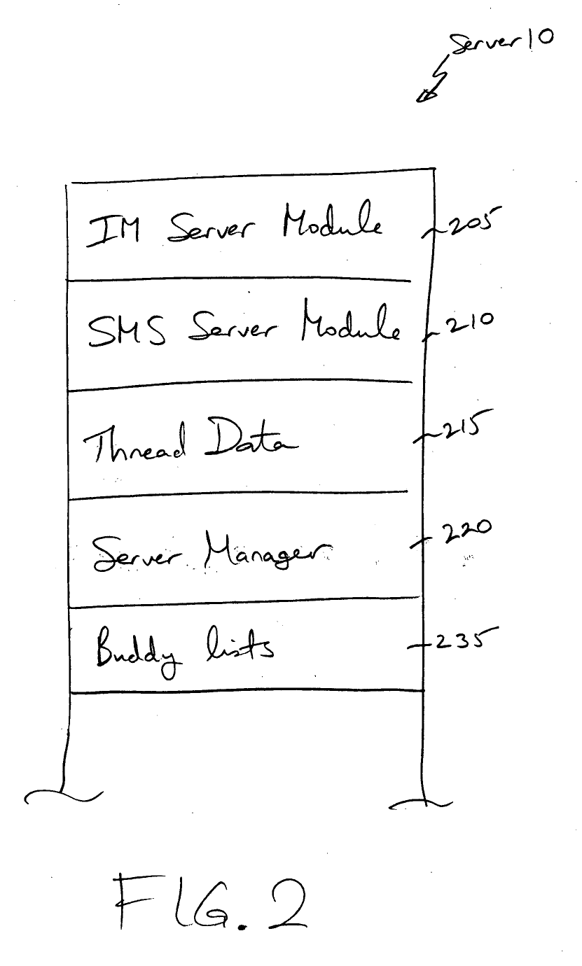

FIG. 2 is a block diagram illustrating details of the server 10. Server 10 includes an IM server module 205, an SMS server module 210, thread data 215, a server manager 220 and buddy lists 225. The server manager 220 controls the operations of the multiprotocol IM server 10.

The IM server module 205 enables GPRS (or other IM protocol) message transmission via the GPRS (or other protocol) links 12, 14, 16 and/or 18 to clients 11, 13, 15 and/or 17. Following the example above, when client 17 initiates the sending of an IM message to his or her buddies, the message is forwarded to the server 10. The server manager 220 instructs the IM server module 205 to send the message via GPRS link 16 to client 15 and a notification flag via GPRS link 14 to client 13.

The SMS server module 210 enables an SMS message (or other offline message) to be transmitted via the SMS (or other offline protocol) links 22, 24, 26 and/or 28 to clients 11, 13, 15 and/or 17. Following the example above, when client 17 initiates the sending of an IM message to his or her buddies, the message is forwarded to the server 10. The server manager 220 instructs the SMS server module 210 to send an invitation via SMS link 22 to client 11.

Thread data 215 includes the chain of messages for each IM session in progress and/or completed. It will be appreciated that thread data 215 may be maintained for only a certain time period or permanently, and may be accessible by only invited guests and/or IM participants. Thread data 215 will likely be stored by thread IDs, so that the different threads can be identified and accessed easily.

The buddy lists 225 includes lists of buddies provided and then selected by each of the instant messaging participants. For example, during initialization of the IM application on a client 11, 13, 15 and/or 17, the server 10 may ask the participant to identify those buddies to be included in his or her buddy list. That way, when the participant wishes to initiate an IM session, the server 10 can enable the client 11, 13, 15 and/or 17 to select from the buddies of his list.

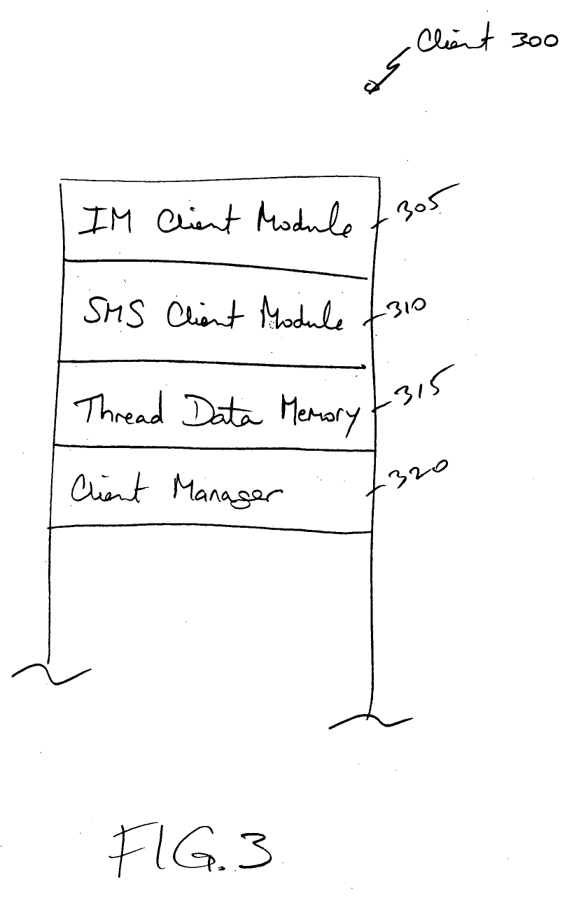

FIG. 3 is a block diagram illustrating details of each of clients 11, 13, 15 and/or 17. Each of clients 11, 13, 15 and/or 17 includes an IM client module 305, an SMS client module 310, thread data memory 315, and a client manager 320. The client manager 320 controls the operations of the client 11, 13, 15 and/or 17.

The IM client module 305 enables GPRS (or other IM protocol) message transmission via the GPRS (or other protocol) links 12, 14, 16 and/or 18 to server 10. Following the example above, when client 17 initiates the sending of an IM message to his or her buddies, the IM client module 305 forwards the instant message via GPRS link 18 to the server 10. The server 10 sends the instant message via GPRS link 16 to the IM client module 305 of client 15 and the thread notification message via GPRS link 14 to the IM client module 305 of client 13.

The SMS client module 310 enables an SMS message (or other offline message) to be transmitted via the SMS (or other offline protocol) links 22, 24, 26 and/or 28 to server 10. Following the example above, when client 17 initiates the sending of an IM message to his or her buddies, the message is forwarded to the server 10. The server manager 220 instructs the SMS server module 210 to send an offline invitation via SMS link 22 to the SMS client module 310 of client 11. When client 11 connects, it will receive the SMS message invitation.

Thread data memory 315 includes memory for storing the chain of messages (including notification messages and SMS messages) for each IM session in progress and/or completed. Thread data 215 will likely be stored by thread IDs, so that the different threads can be identified and accessed easily. Because of the typically limited memory in the clients 11, 13, 15 and/or 17, the message data will likely be stored in thread data memory 315 temporarily, and retrieved from the server 10 if needed in the future.

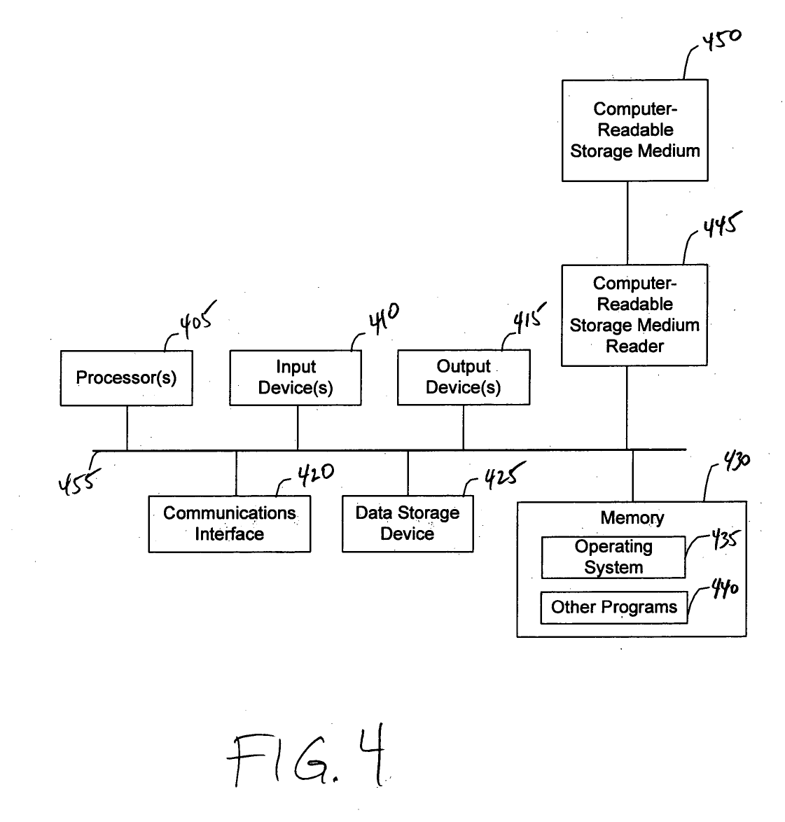

FIG. 4 is a block diagram illustrating details of an example computer system 400, such that each of clients 11, 13, 15, 17 and/or server 10 may be an instance. Computer system 400 includes a processor 405, such as an ARM microprocessor, an Intel Pentium® microprocessor or a Motorola Power PC® microprocessor, coupled to a communications channel 455. The computer system 400 further includes an input device 410 such as a keyboard or mouse, an output device 415 such as a liquid crystal tube display, a communications interface 420, a data storage device 425 such as a magnetic disk, and memory 430 such as Random-Access Memory (RAM), each coupled to the communications channel 455. The communications interface 420 may be coupled to a network such as the wide-area network commonly referred to as the Internet. One skilled in the art will recognize that, although the data storage device 425 and memory 430 are illustrated as different units, the data storage device 425 and memory 430 can be parts of the same unit, distributed units, virtual memory, etc.

The data storage device 425 and/or memory 430 may store an operating system 435 such as the Symbian™ Operating system, Microsoft Windows CE or Windows/95 Operating System (OS), the IBM OS/2 operating system, the MAC OS, or UNIX operating system and/or other programs 440 such as a Java engine (J2ME). It will be appreciated that a preferred embodiment may also be implemented on platforms and operating systems other than those mentioned. An embodiment may be written using JAVA, C, and/or C++ language, or other programming languages, possibly using object oriented programming methodology.

One skilled in the art will recognize that the computer system 400 may also include additional information, such as network connections, additional memory, additional processors, LANs, input/output lines for transferring information across a hardware channel, the Internet or an intranet, etc. One skilled in the art will also recognize that the programs and data may be received by and stored in the system in alternative ways. For example, a computer-readable storage medium (CRSM) reader 445 such as a magnetic disk drive, hard disk drive, magneto-optical reader, CPU, etc. may be coupled to the communications bus 455 for reading a computer-readable storage medium (CRSM) 450 such as a magnetic disk, a hard disk, a magneto-optical disk, RAM, etc. Accordingly, the computer system 400 may receive programs and/or data via the CRSM reader 445. Further, it will be appreciated that the term “memory” herein is intended to cover all data storage media whether permanent or temporary.

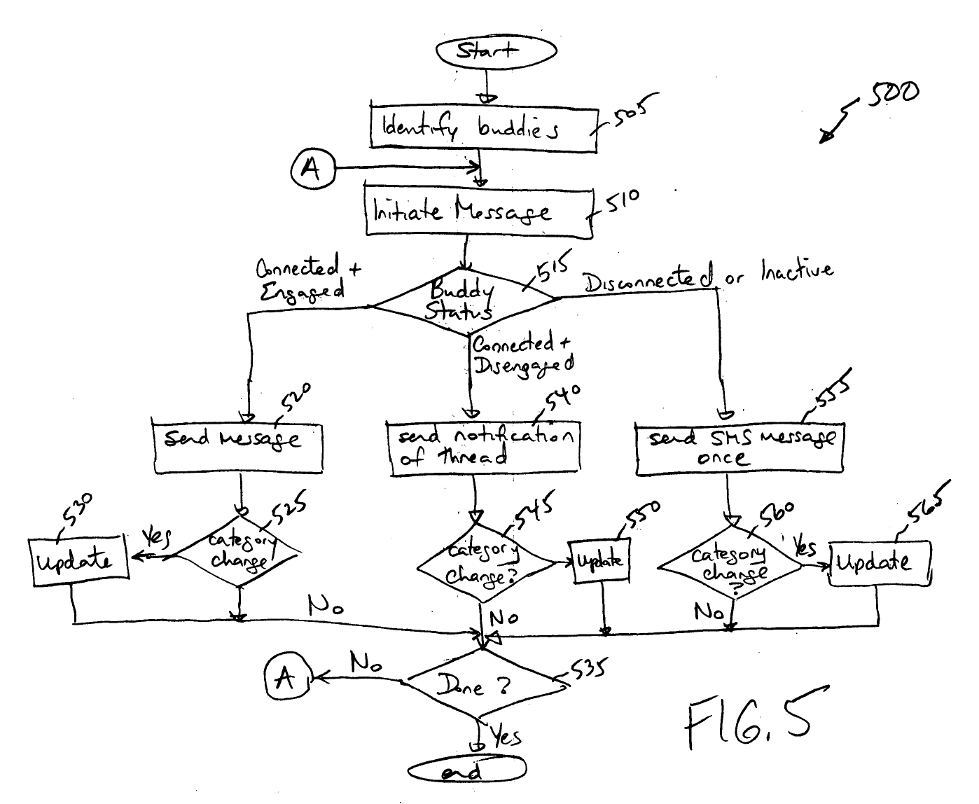

FIG. 5 is a flowchart illustrating a method 500 enabling instant messaging to a group of participants and notifications to those disconnected and/or inactive. Method 500 may be implemented using network system 5. Method 500 begins in step 505 with the user identifying his or her buddies. This identification step may be completed at different times, e.g., a first list of buddies can be prepared during initialization, additional buddies can be added to the first list at times thereafter, multiple lists can be made, and sub-lists (or entire lists) can be selected for particular IM sessions. After buddies are selected in step 505, the user initiates an instant message in step 510. Following the example above, client 17 may initiate the session and the instant message, and the message may be forwarded to the server 10. In step 515, the buddy statuses of those buddies identified as recipients are determined. In the ongoing example, the server 10 determines the status of each buddy as (1) active, connected and engaged, (2) active, connected and disengaged, or (3) inactive or disconnected.

If a buddy is active, connected and engaged, method 500 proceeds to step 520, where the message is sent to the buddy. In this example, the server 10 sends the message to all the buddies who are active, connected and engaged. In step 525, if the status of the buddy continues to be active, connected and engaged, then the method 500 in step 535 determines whether the IM session has ended. If so, then method 500 ends. If not, then method 500 returns to step 510 for additional messages to be sent. If the status of the buddy changes, then method 500 jumps to step 530 to address this change. For example, if the buddy disengages, then the method 500 may send the buddy a notification of the ongoing session, should he or she wish to re-engage. If the buddy disconnects, then the method 500 may send the buddy an SMS message to provide him the link to reconnect. Alternatively, the link may remain if a previously connected buddy becomes disconnected or disengaged.

If a buddy is active, connected and disengaged, then method 500 proceeds to step 540 where a notification of the session is sent to the buddy. The notification may include an ID, a name of the initiator, a number of messages waiting therein, etc. This message will be sent only once, or may be updated as the session continues. For example, only one ID need be sent. However, if the notification includes a number of messages, the number will need to be updated. In step 545, the method 500 determines whether the status of the buddy changes. If not, then method 500 jumps to step 535 to determine whether the session has ended. If the status of the buddy changes, then the method proceeds to step 550 to update the buddy. For example, if the buddy becomes active, connected and engaged, then all previous messages can be sent to the buddy and the buddy can begin to receive messages as they are sent. For another example, if the buddy disconnects, then the method 500 can send the buddy an SMS message to provide him the link to reconnect.

If the buddy is inactive or disconnected, then the method 500 proceeds to step 555, where an SMS message is sent to the buddy to inform him or her of an IM session available. In step 560, the method 500 determines whether the status of the buddy changes. If not, then method 500 proceeds to step 535 to determine if the session has completed. If so, then method 500 proceeds to step 565 to update the buddy. For example, if the buddy becomes active, connected and disengaged, then a thread notification of the IM session (whether ongoing or completed) may be given to the buddy. If the buddy becomes active, connected and engaged, then the method 500 can provide the buddy all prior messages and ongoing messages, if the session is still in progress.

In a specific example of method 500, server 10 sends an SMS message to client 11 inviting him to join the IM session. Following the invitation, client 11 may launch the client manager 220 (e.g., the IM application), which connects to the server 10 in GPRS. The server 10 identifies the client 11 as active and disconnected. The client 11 requests connection. The server 10 returns the list of threads (sessions) available, possibly with the number of messages unread for each thread. The client 11 then requests to view a thread. The server 10 returns the messages that the client 11 has not yet read. Accordingly, a user can review messages that were exchanged through instant messaging even if he was disconnected when the messages were originally sent. Further, if the session is still ongoing, the client 11 can join in the messaging. As the server 10 receives the request from client 11 to join a thread, the server 10 may notify the other clients 13, 15 and/or 17 that are subscribed to that thread that client 11 is now active, connected and engaged in the thread.

The foregoing description of the preferred embodiments of the present invention is by way of example only, and other variations and modifications of the above-described embodiments and methods are possible in light of the foregoing teaching. Although the network sites are being described as separate and distinct sites, one skilled in the art will recognize that these sites may be a part of an integral site, may each include portions of multiple sites, or may include combinations of single and multiple sites. The various embodiments set forth herein may be implemented utilizing hardware, software, or any desired combination thereof. For that matter, any type of logic may be utilized which is capable of implementing the various functionality set forth herein. Components may be implemented using a programmed general purpose digital computer, using application specific integrated circuits, or using a network of interconnected conventional components and circuits. Connections may be wired, wireless, modem, etc. The embodiments described herein are not intended to be exhaustive or limiting. The present invention is limited only by the following claims.

1. A method comprising:
initiating an instant messaging session;
sending an instant message to a buddy;
if the buddy is connected and engaged, then sending the instant message to the buddy; and
if the buddy is disconnected, then sending an offline notification to the buddy.

2. The method of claim 1, wherein, if the buddy is connected and engaged, then the instant message is sent to the buddy using a GPRS protocol.

3. The method of claim 1, wherein the offline notification is an SMS message indicating that an instant messaging session is available to the buddy.

4. The method of claim 1, wherein the offline notification is an MMS message indicating that an instant messaging session is available to the buddy.

5. The method of claim 1, further comprising
if the buddy is connected and disengaged, then sending a notification identifying the instant messaging session to the buddy.

6. A method comprising:
receiving by a buddy an offline notification that an instant messaging session is available;
accessing a server in which a plurality of instant messaging sessions are stored;
receiving identification of the instant messaging session from the server;
enabling access to the instant messaging session; and
enabling review of the messages of the instant messaging session.

7. The method of claim 6, wherein the identification of the instant messaging session is based on the identification of the buddy.

8. The method of claim 6, wherein the instant messaging session is ongoing.

9. The method of claim 6, wherein the instant messaging session has ended.

10. The method of claim 6, wherein the receiving, the enabling access, and the enabling review are use the GPRS protocol.

11. The method of claim 6, wherein the offline notification is an SMS message indicating that an instant messaging session is available to the buddy.

12. The method of claim 6, wherein the offline notification is an MMS message indicating that an instant messaging session is available to the buddy.

13. A method comprising:
launching an instant messaging session;
receiving a list of predefined buddies from a server;
enabling selection of at least one of the buddies from the predefined list for an instant messaging session; and
initiating the sending of an instant message to the selected at least one buddy.

14. The method of claim 13, further comprising:
if the buddy is connected and engaged, then sending the instant message to the buddy;
if the buddy is connected and disengaged, then sending a notification of the instant messaging session to the buddy to enable access to the instant message session; and
if the buddy is disconnected, then sending to the buddy an offline message indicating that an instant message session is available to the buddy.

15. The method of claim 14, wherein the instant message is sent via GPRS.

16. The method of claim 14, wherein the notification of the instant message is sent via GPRS.

17. The method of claim 14, wherein the offline message is an SMS notification.

18. The method of claim 14, wherein the offline message is an SMS notification.

19. A method comprising:
launching an instant messaging session;
receiving a list of available chat sessions;
enabling selection of one of the chat sessions;
receiving the latest messages in the selected session, including unread ones, if any;
initiating the sending of an instant message to the other participants in the session.
